(19) United States
(12) Patent Application Publication
(10) Pub. No.: US 2016/0028923 A1
(43) Pub. Date: Jan. 28, 2016

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Hiroshi Yasuhara, Yokohama-shi (JP)

(21) Appl. No.: 14/797,448

(22) Filed: Jul. 13, 2015

(30) Foreign Application Priority Data
Jul. 23, 2014 (JP) 2014-150133

(51) Int. Cl. H04N 1/44; H04N 1/00

(52) U.S. Cl. CPC H04N 1/4433; H04N 1/00464; H04N 1/00413; H04N 1/00474; H04N 2201/0094

(57) ABSTRACT

The present invention provides an information processing apparatus having a browser function and a method of controlling an information processing apparatus. A button to be displayed on a menu screen, a function associated with the button, and information regarding whether the button has an attribute of the bookmark information are stored as button information. If the button information of a button included in the menu screen is the bookmark information when displaying the menu screen, it is determined whether or not the function category information of the bookmark information corresponds to a function that is restricted to a user who has logged in. If it is determined that the function category information of the bookmark information is restricted to the user, the menu screen is displayed such that a button corresponding to the bookmark information cannot be operated.

### BACKGROUND OF THE INVENTION

1. Field of the Invention

The present invention relates to an information processing apparatus, a method of controlling an information processing apparatus, and a storage medium.

2. Description of the Related Art

An information processing apparatus such as a PC being connected to a Web server in a network and displaying an operation screen provided by a Web application of the Web server using a Web browser provided on the information processing apparatus is known. In this case, initially, the Web browser of the information processing apparatus makes a request for the operation screen to the Web application of the Web server. Then, the Web application replies (responds) to this request by transmitting HTML data for displaying the operation screen on the Web browser to the information processing apparatus. The Web browser of the information processing apparatus thereby analyzes the received HTML data and displays the operation screen that is based on a description of the HTML data. Furthermore, upon a user inputting an instruction via the operation screen displayed by the Web browser, the Web browser notifies the Web server of the input instruction. The Web application of the Web server that receives this notification then executes processing in accordance with the input instruction.

In recent years, some multi-function peripherals (MFPs) having a scan function and a print function are provided with the aforementioned Web browser. There are Web browsers of such MFPs that can register a bookmarked Web site as a shortcut button in a top menu of the MFP (see Japanese Patent Laid-Open No. 2013-54435). A user can thereby directly access the Web application from the top menu of the MFP as in the case of accessing a normal application, rather than by accessing the target Web application from a menu on the Web browser. Also, the Web browser of the MFP is often used for the main purpose of using a Web application, and in this case, registration of a bookmark and of a site in the top menu can be performed only by an administrator for security reasons. Meanwhile, for example, Japanese Patent Laid-Open No. 2011-76621 describes restriction of access to a function provided by an MFP in accordance with authority of a user.

In the case of restricting access to a function provided by the MFP, it is desirable that access to not only a function implemented in the MFP but also a function implemented by a Web application is restricted. However, a conventional bookmark shortcut button holds only URL information and does not additionally hold information regarding what kind of function the Web application to be connected implements, and therefore appropriate access restriction cannot be carried out. For example, the MFP cannot determine from the URL information whether the Web application has a print function, or whether the Web application has a function of transmitting a scanned image. Accordingly, even a user whose access to a function of scanning and transmitting an image is restricted can achieve the scanning and transmission via the Web application, and accordingly the security level degrades.

On the other hand, in the case of a user whose access to a browser function is restricted, access to the Web server by this user is restricted regardless of the function that the Web application has. Accordingly, for example, in the case of a user whose access to the browser function is restricted and who has the authority to access the function of transmitting a scanned image, access to a Web application having a scan function by this user is also restricted. That is to say, a problem arises in that even though the user is permitted to access the function of transmitting a scanned image, the user cannot perform scan/transmission processing using the Web application.

### SUMMARY OF THE INVENTION

An aspect of the present invention is to eliminate the above-mentioned problems with the conventional techniques.

A feature of the present invention is to provide a technique by which restriction of access to a function implemented by a browser function can be imposed on a user in accordance with the function implemented by the browser function.

According to a first aspect of the present invention, there is provided an information processing apparatus having a browser function, the apparatus comprising: a first storing unit configured to store access restriction information regarding restriction of access to a function, in association with a user; a holding unit configured to hold, as bookmark information, a URL of a connection destination and function category information indicating a function of the connection destination; a second storing unit configured to store, as button information, information of a button to be displayed on a menu screen and a function associated with the button, and information regarding whether the button has an attribute of the bookmark information; a determination unit configured to determine, if the button information of a button included in the menu screen is the bookmark information when displaying the menu screen, whether or not the function category information of the bookmark information corresponds to a function that is restricted by the access restriction information corresponding to a user who has logged in; and a control unit configured to perform control for displaying the menu screen such that a button corresponding to the bookmark information is not able to be operated, if it is determined by the determination unit that the function category information of the bookmark information corresponds to the function that is restricted by the access restriction information corresponding to the user who has logged in.

According to a second aspect of the present invention, there is provided a method of controlling an information processing apparatus having a browser function, the method comprising: storing access restriction information regarding restriction of access to a function, in association with a user; holding, as bookmark information, a URL of a connection destination and function category information indicating a function of the connection destination; storing, as button information, information of a button to be displayed on a menu screen and a function associated with the button, and information regarding whether the button has an attribute of the bookmark information; determining, if the button information of a button included in the menu screen is the bookmark information when displaying the menu screen, whether or not the function category information of the bookmark information corresponds to a function that is restricted by the access restriction information corresponding to a user who has logged in; and performing control for displaying the menu screen such that a button corresponding to the bookmark information is not able to be operated, if it is determined in the determining that the function category information of the bookmark information corresponds to the function that is restricted by the access restriction information corresponding to the user who has logged in.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing an exemplary configuration of a network system using a multi-function peripheral (MFP) according to an embodiment of the present invention.

FIG. 2 is a block diagram illustrating a hardware configuration of the MFP according to an embodiment.

FIG. 3 is a block diagram illustrating a hardware configuration of a server according to an embodiment.

FIG. 4 is a functional block diagram illustrating a software configuration of an overall network system according to an embodiment.

FIG. 5 is a diagram showing an exemplary user management table according to an embodiment.

FIG. 6 is a diagram showing an exemplary bookmark information table held in a bookmark management module according to an embodiment.

FIG. 7 is a diagram showing an exemplary button information table managed by a button management module according to an embodiment.

FIG. 8 is a diagram showing an exemplary authentication screen displayed on a display unit of the MFP according to an embodiment.

FIGS. 9A and 9B are diagrams each showing an exemplary top menu screen displayed on the display unit of the MFP according to an embodiment.

FIG. 10 is a flowchart for describing processing from user authentication up to display of the top menu in the MFP according to an embodiment.

FIG. 11 is a flowchart for describing top menu display processing in step S1007 in FIG. 10.

FIGS. 12A to 12C are diagrams each showing an exemplary screen of a print Web application displayed by a Web browser of the MFP according to an embodiment.

FIG. 13 is a flowchart for describing bookmark registration processing performed by the MFP according to an embodiment.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Although the following embodiment will describe an information processing apparatus according to the present invention while taking an multi-function peripheral (MFP) as an example thereof, the information processing apparatus in the present invention is not limited to such a multi-function peripheral, and may also be a PC or a mobile terminal.

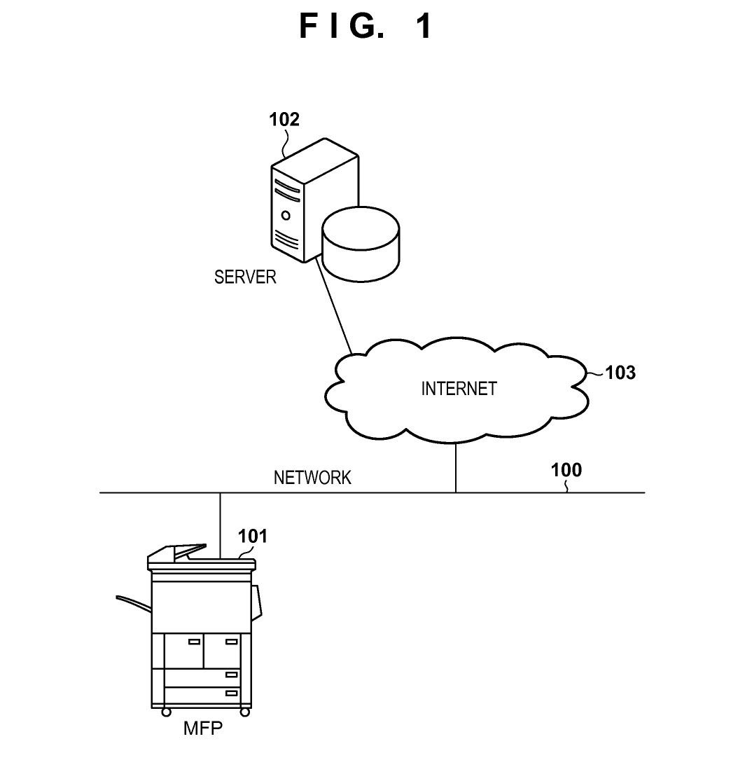

FIG. 1 is a diagram showing an exemplary configuration of a network system using a multi-function peripheral (MFP) 101 according to an embodiment of the present invention.

This network system has the MFP 101 and a server 102 that are connected via a network 100. The network 100 is a base for communication performed between the apparatuses, and is connected to the Internet 103. The MFP 101 has a scan function, a print function, a box function, and the like, and further has a Web browser function. This MFP 101 may be managed using a local IP address. In this case, a gateway (not shown) exists between the network 100 and the MFP 101, and address conversion is performed by this gateway. Also, for example, the gateway includes a router, and this gateway and the MFP 101 may be provided with a firewall function. The server 102 has a function of distributing Web content via the network, and returns the Web content in accordance with a request from the MFP 101. The network does not necessarily need to be connected to the Internet, and the MFP 101 and the server 102 may exist in a local network. Another plurality of MFPs, PCs, and the like may further be connected to the network, but these are omitted here.

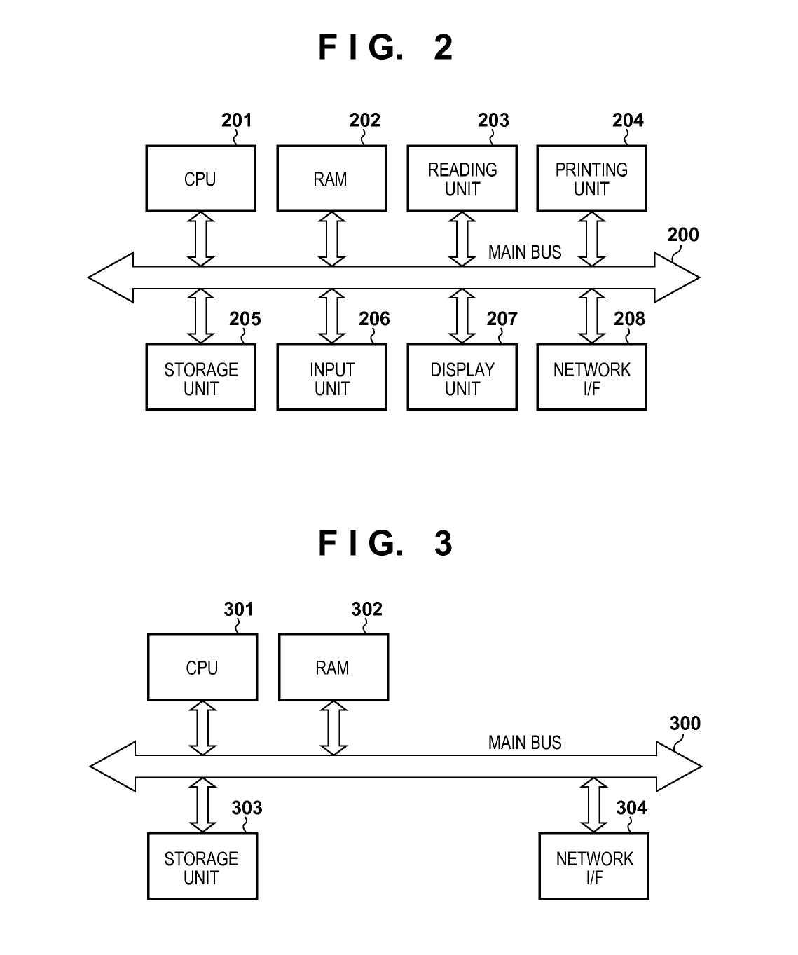

FIG. 2 is a block diagram illustrating a hardware configuration of the MFP 101 according to an embodiment.

A CPU 201 executes a program deployed in a RAM 202 from a storage unit 205 and performs later-described control according to the present embodiment. The RAM 202 provides a work area and an area for the CPU 201 deploying a program, and is used to temporarily store various data. A reading unit 203 reads an image of an original and outputs image data of this image. A printing unit 204 prints an image on a recording medium such as a sheet in accordance with print data provided from the CPU 201. The storage unit 205 stores a program to be executed by the CPU 201, various kinds of setting information, and the like, and includes a HDD (hard disk drive), an NVRAM, or the like, for example. An input unit 206 accepts a user operation and inputs a command input by the user. A display unit 207 displays a message for the user, a menu screen, and the like. Note that this display unit 207 may have a touch panel function. A network I/F 208 communicates with other devices via the network 100. The above-described units are connected to one another via a main bus 200.

Note that, in the present embodiment, the CPU 201 controls the RAM 202, the reading unit 203, the printing unit 204, the storage unit 205, the input unit 206, the display unit 207, and the network interface 208 via the main bus 200, unless otherwise stated. Furthermore, the display unit 207 may also serve as the input unit 206, as in the case of a touch panel display.

FIG. 3 is a block diagram illustrating a hardware configuration of the server 102 according to the embodiment.

A CPU 301 executes a program deployed in a RAM 302 from a storage unit 303 and performs control according to the present embodiment. The RAM 302 provides a work area and an area for the CPU 301 deploying a program, and is used to temporarily store various data. The storage unit 303 stores a program to be executed by the CPU 301, various kinds of setting information, and the like, and includes a HDD (hard disk drive), an NVRAM, or the like, for example. A network I/F 304 communicates with other devices via a network. The above-described units are connected to one another via a main bus 300. Note that, in the present embodiment, the CPU 301 controls the RAM 302, the storage unit 303, and the network interface 304 via the main bus 300, unless otherwise stated.

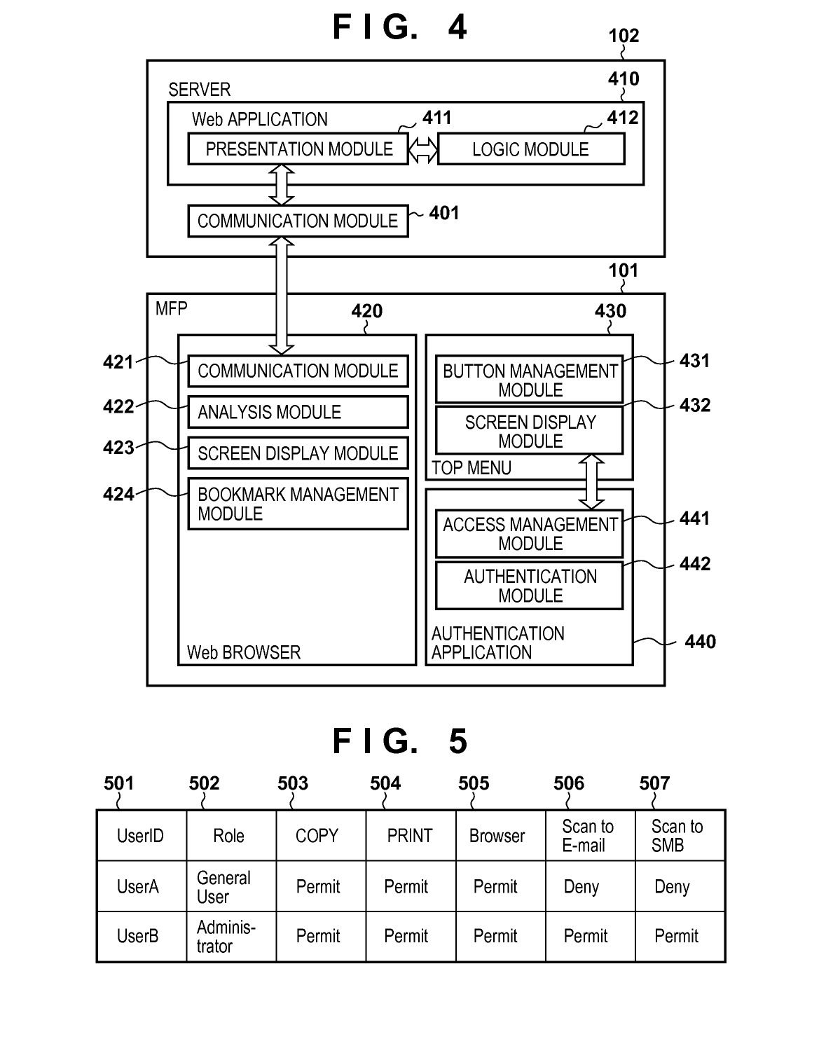

FIG. 4 is a functional block diagram illustrating a software configuration of an overall network system according to the embodiment. Note that each functional modules shown in FIG. 4 is achieved by the CPU 201 and the CPU 301 respectively in the MFP 101 and the server 102 executing respective control programs.

The server 102 has a Web application 410 and a communication module 401. Furthermore, the Web application 410 includes a presentation module 411 and a logic module 412. The presentation module 411 receives a request from the MFP 101 via the communication module 401, and transmits, to the MFP 101, an operation screen and a result screen that are to be displayed by a Web browser 420 of the MFP 101 as responses. The presentation module 411 also receives, from the MFP 101, input information from the user that is input via the operation screen displayed by the Web browser 420 of the MFP 101, via the communication module 401. The logic module 412 performs processing with respect to the input information from the MFP 101 delivered from the presentation module 411. For example, the logic module 412 changes screen information to be displayed and creates a processing request for executing a device function (not shown) of the MFP 101 in accordance with input by a user operation. The communication module 401 is a software module that controls the network interface 304 to perform communication in conformity with the HTTP protocol.

Next, the MFP 101 will be described. The MFP 101 has the Web browser 420, a top menu 430, and an authentication application 440. Each of the Web browser 420, the top menu 430, and the authentication application 440 is achieved by the CPU 201 in the MFP 101 executing a control program. Note that the Web browser 420 is not limited to a Web browser that displays content provided by the server 102. Similarly, the server 102 is not limited to a Web server that transmits and receives a request/response in accordance with the HTTP protocol. The Web browser 420 need only have a function of acquiring content by communicating with any server and displaying the acquired content on a screen.

The Web browser 420 has a communication module 421, an analysis module 422, a screen display module 423, and a bookmark management module 424. The communication module 421 communicates with the network interface 208, and with the presentation module 411 of the Web application 410 via the communication module 401 of the server 102, in accordance with the HTTP protocol. More specifically, the communication module 421 transmits information input by the user via the operation screen displayed on the Web browser 420, as a request to the Web application 410. The communication module 421 also receives a response transmitted from the Web application 410.

The analysis module 422 analyzes the response received from the Web application 410. This response contains HTML data, which is a description indicating content of the operation screen to be displayed on the Web browser 420. The screen display module 423 displays, on the display unit 207, the operation screen that is based on the HTML data and executes a JavaScript file on currently-displayed content based on a result of the analysis performed by the analysis module 422.

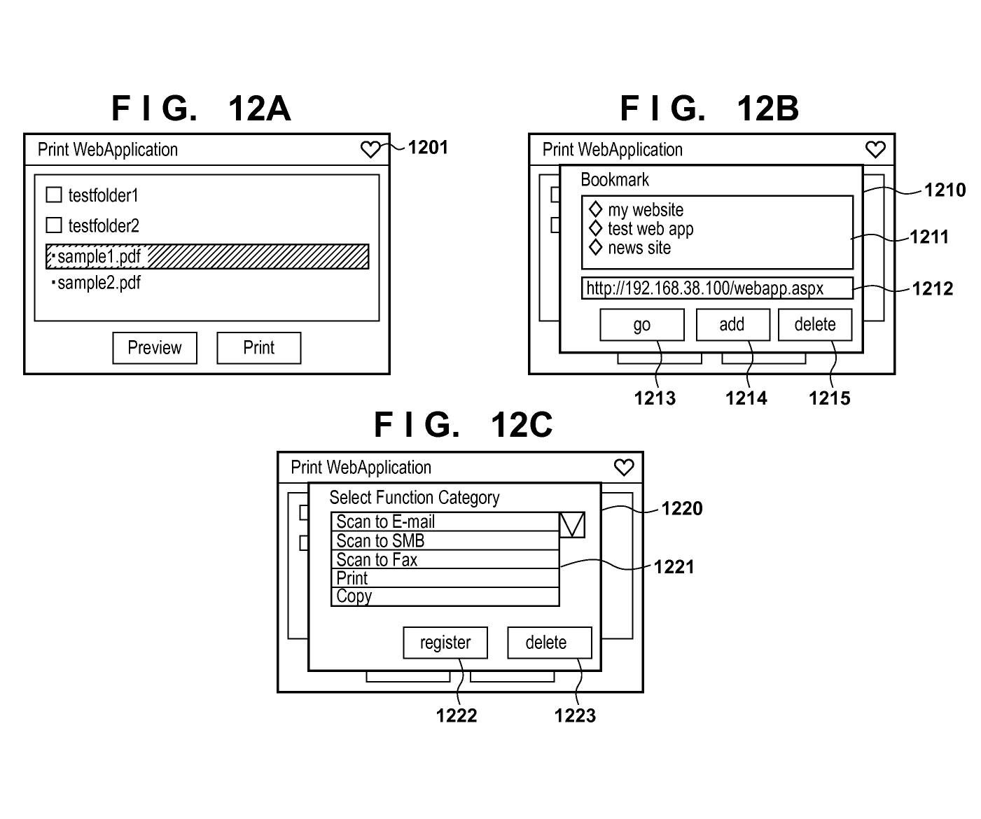

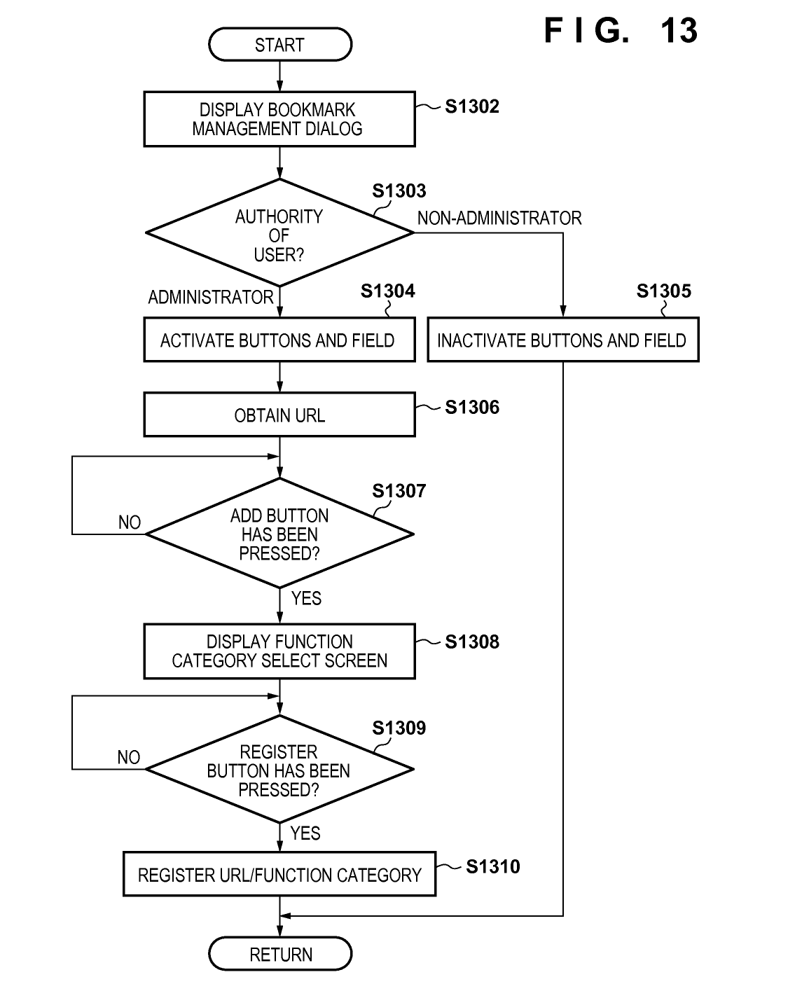

The bookmark management module 424 stores information of a bookmark registered by a user operation. In the case where one bookmarked site is selected by a user operation via a bookmark management dialog 1210 (FIG. 12B), the bookmark management module 424 causes the Web browser 420 to load a URL of this site.

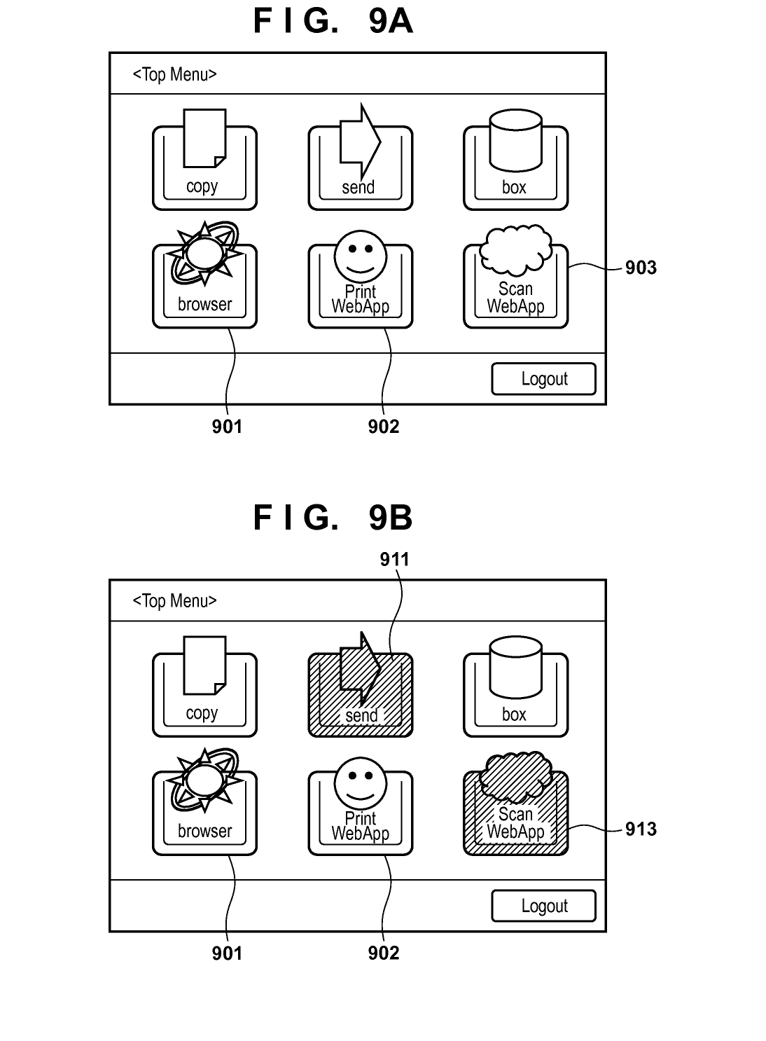

The top menu 430 has a button management module 431 and a screen display module 432. The button management module 431 stores information of a button to be displayed in the top menu. Specifically, this button information contains information such as an image and a character string to be displayed with a button, an application to be started when this button is pressed, and a parameter at the time of starting the application. The screen display module 432 displays a top menu screen (FIGS. 9A and 9B) in accordance with the button information registered in the button management module 431. In the case where any button displayed in the top menu is selected by a user operation, the screen display module 432 starts an application corresponding to the selected button.

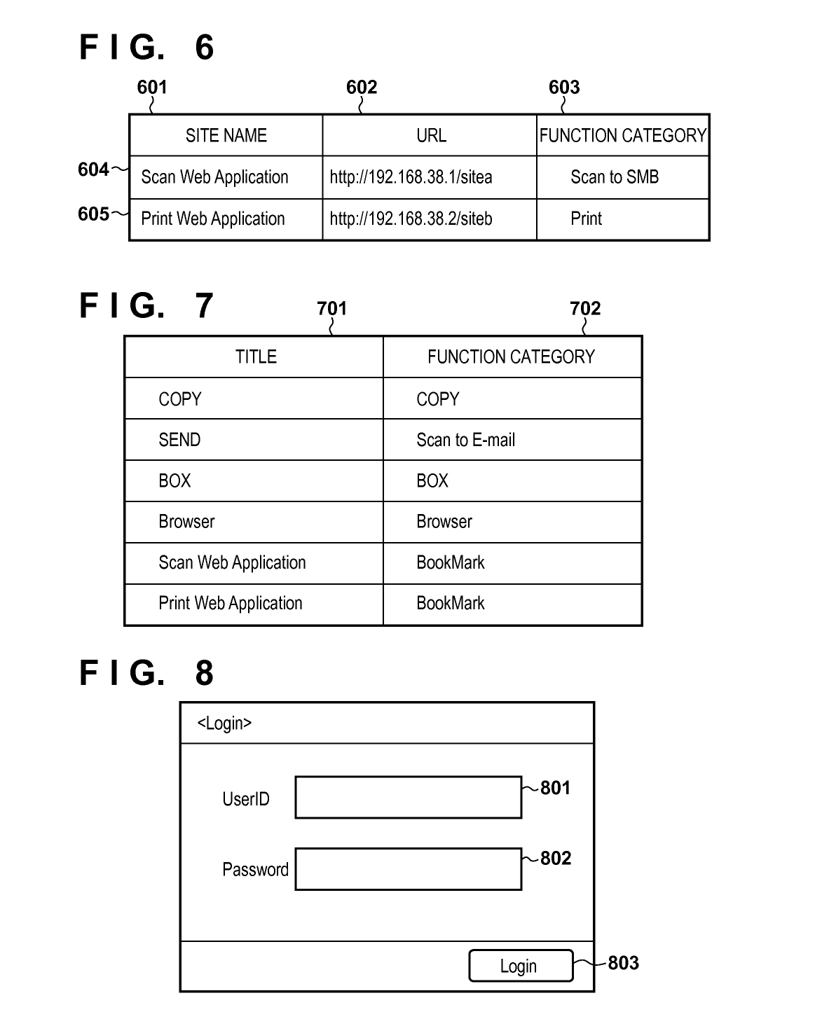

The authentication application 440 performs user authentication in the MFP 101. Specifically, the authentication application 440 performs authentication processing for identifying the user by an authentication module 442, and performs processing for activating and inactivating a button in the top menu via an access management module 441. The authentication module 442 performs user authentication processing. Specifically, when the user is in a state of not having been authenticated by the MFP 101, the authentication module 442 displays an authentication screen (FIG. 8) on the display unit 207 and accepts input of authentication information from the user via the input unit 206. Furthermore, the authentication module 442 transmits the input authentication information to an external authentication server and receives an authentication result via the network interface 208, or performs authentication by referencing the authentication information of the user held in the storage unit 205. Note that the storage destination of the authentication information of the user, an algorithm and an input method for the authentication, and the like are not limited here. The access management module 441 controls access by a user. Specifically, the access management module 441 references access restriction information (FIG. 5) of a user authenticated by the authentication module 442, function category information (FIG. 7) associated with buttons in the top menu, and bookmark information table (FIG. 6). The access management module 441 then determines to inactivate or activate buttons in the top menu based on the referenced information. After thus determining to inactivate or activate buttons in the top menu, the access management module 441 displays the top menu shown in FIG. 9A or 9B, for example.

FIG. 5 is a diagram showing an exemplary user management table according to the embodiment.

This user management table is managed while being stored in the storage unit 205 by the access management module 441 of the authentication application 440. This user management table holds a user identifier 501, a user role (authority) information 502, and information of restriction on the user regarding functions 503 to 507. Here, information of restriction on each user regarding a copy function 503, a print function 504, a browser function 505, a Scan-to-E-mail function 506, and a Scan-To-SMB function 507 is registered. “Permit” is registered as the restriction information if a function is available, and “Deny” is registered as the restriction information if a function is not available, i.e., a function is restricted. For example, a user identifier “UserA” in FIG. 5 has general user authority, and use of the Scan-To-E-mail function 506 and the Scan-To-SMB function 507 by the user identifier “UserA” is restricted. It is also indicated that a user identifier “UserB” has administrator authority (“Administrator”) and can access all functions.

FIG. 6 is a diagram showing an exemplary bookmark information table held in the bookmark management module 424 according to the embodiment. Each record registered in the bookmark information table corresponds to a book mark registered in the MFP 101.

Numeral 601 denotes the name of a site used by the registered bookmark. Numeral 602 denotes a URL of the site, and a URL of a Web application to be connected is held here. Numeral 603 denotes function category information, and information indicating the function that the Web application to be connected has is held here. The information that can be held as this function category information is defined in advance by the access management module 441.

In FIG. 6, a row 604 denotes a URL of a scan Web applications and the function category information (Scan to SMB) thereof. A row 605 denotes a URL of a print Web application and the function category information (Print) thereof.

FIG. 7 is a diagram showing an exemplary button information table managed by the button management module 431 according to the embodiment.

This table holds a title 701, which is title information of a button, and function category information 702 corresponding to the button. Note that information of a bookmark shortcut button is also registered in this table, and the shortcut button having an attribute of a bookmark is registered with “BookMark” as a function category.

Here, “copy”, “SEND (Scan To Send)”, “BOX”, “Browser”, “scan Web application”, and “print Web application” are registered as buttons to be displayed in the top menu. Here, the function categories of the scan Web application and the print Web application are registered as “BookMark”, which explicitly indicates that the buttons are bookmark shortcut buttons.

FIG. 8 is a diagram showing an exemplary authentication screen displayed on the display unit 207 of the MFP 101 according to the embodiment.

This screen is displayed by the authentication module 442 of the authentication application 440 when a user is in a state of not having been authenticated by the MFP 101. A user ID input field 801 accepts input of a user identifier from the user. A user password input field 802 accepts input of a password from the user. After the user ID and the password are input in these input fields, upon a login button 803 being pressed, user authentication processing is performed by the authentication module 442 based on the input user ID and password. If the user authentication is successful here, the top menu shown in FIG. 9A is displayed on the display unit 207, for example.

FIG. 9A is a diagram showing an exemplary top menu screen displayed on the display unit 207 of the MFP 101 according to the embodiment.

Start buttons of respective applications installed in the MFP 101 are displayed on this top menu screen, and each plays a role of a launcher. Information of the buttons displayed on the top menu screen is stored in the button management module 431, and is displayed on the screen of the display unit 207 by the screen display module 432.

The top menu screen shown in FIG. 9A includes a Web browser button 901 and Web application shortcut buttons 902 and 903. The Web browser button 901 is a button for starting the Web browser 420, and upon a user indicating this button, a screen of the Web browser 420 is displayed on the display unit 207. The Web application shortcut buttons 902 and 903 are bookmark shortcut buttons of Web sites that are bookmarked on the Web browser 420. Specifically, upon the user indicating the shortcut button 902, the top menu 430 starts the Web browser 420 and delivers a URL associated with the button 902 as a parameter at the time of starting the Web browser 420. Thereby, upon the Web browser 420 being started, the URL associated with this button 902 is loaded. However, an identifier for identifying the bookmark may be delivered here as a parameter in place of the URL. Note that, here, the Web application shortcut buttons 902 and 903 correspond respectively to the print Web application denoted by the row 605 and the scan Web application denoted by the row 604 in FIG. 6.

FIG. 9B is a diagram showing an exemplary top menu screen in the case where access restriction is performed in the present embodiment.

For example, in the case where “UserA” registered in the user management table in FIG. 5 is authenticated by the MFP 101, use of the Scan-To-SMB function and the Scan-To-E-mail function by this “UserA” is restricted, as mentioned above. For this reason, buttons (in FIG. 9B, buttons 911 and 913) corresponding to these functions are specified by the tables in FIGS. 6 and 7 and displayed while being grayed out, and operations to these buttons are inactivated by the access management module 441. Accordingly, the user “UserA” is in a state of being unable to operate these buttons 911 and 913.

On the other hand, if “UserB” is authenticated by the MFP 101, since “UserB” is an administrator and can use all functions, inactivation of buttons is not performed, and operations to all buttons are enabled as shown in FIG. 9A, for example.

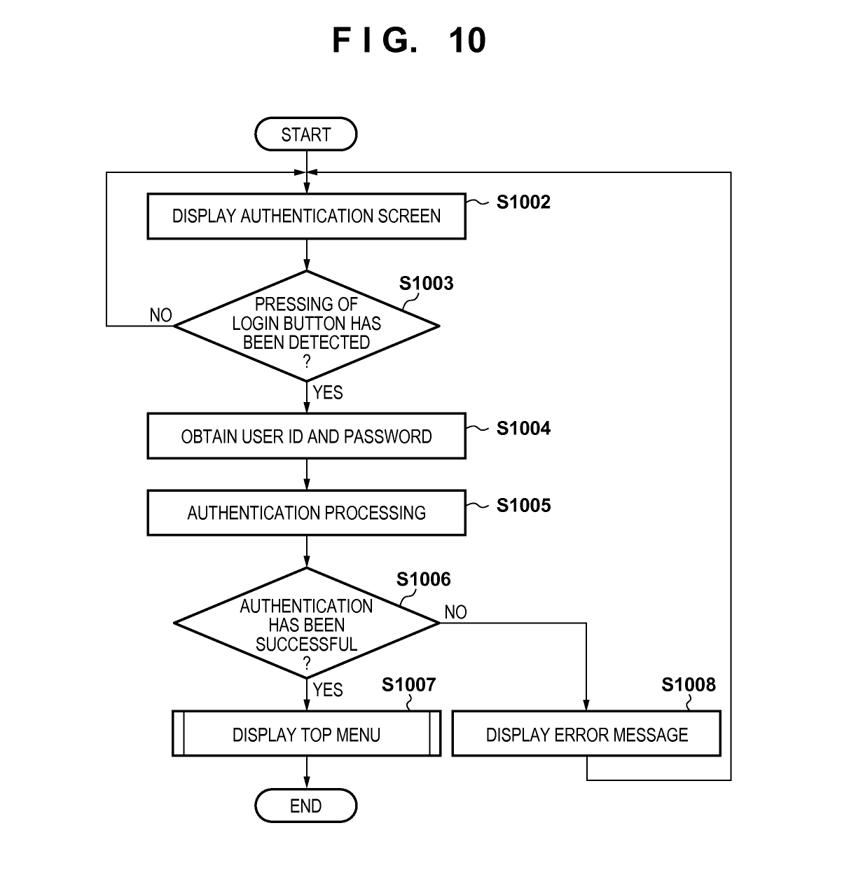

FIG. 10 is a flowchart for describing processing from user authentication up to display of the top menu in the MFP 101 according to the embodiment. A program for executing this processing is stored in the storage unit 205, and at the time of the execution, the program is deployed in the RAM 202 and executed by the CPU 201, and the processing shown by this flowchart is thereby achieved.

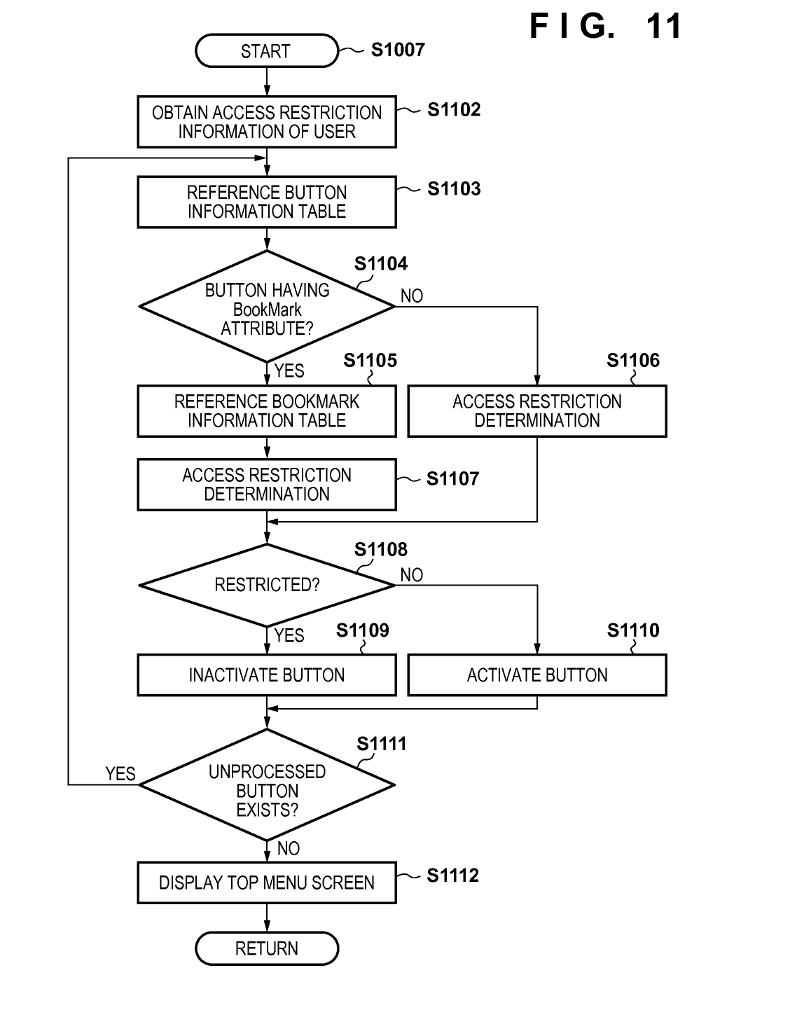

Initially, in step S1002, the CPU 201 displays the authentication screen shown in FIG. 8, for example. Next, the processing proceeds to step S1003, the CPU 201 determines whether or not the login button 803 in the authentication screen has been pressed by the user, and if it is detected that the login button 803 has been pressed, the processing proceeds to step S1004. In step S1004, the CPU 201 obtains a user ID and a password that are input via the authentication screen. Here, the user ID is a user ID that is input in the user ID input field 801 in the authentication screen, and the password is a password that is input in the password input field 802. The processing then proceeds to step S1005, and the CPU 201 performs user authentication based on whether or not the user authentication information held in the storage unit 205 of the MFP 101 coincides with the user ID and the password that are obtained in step S1004. If the CPU 201 determines in step S1006 that user authentication has been successful, the processing proceeds to step S1007, the CPU 201 displays the top menu on the display unit 207, and ends the processing. In this step S1007, processing for activation and inactivation of the buttons displayed in the top menu is performed based on the access restriction information of the user, as described later using a flowchart in FIG. 11. On the other hand, if the user authentication has failed in step S1006, the processing proceeds to step S1008, the CPU 201 displays an error message on the display unit 207 and ends the processing.

FIG. 11 is a flowchart for describing top menu display processing in step S1007 in FIG. 10.

Initially, in step S1102, the CPU 201 obtains the access restriction information of the user. Here, the CPU 201 obtains the access restriction information of an authenticated user from, for example, the user management table in FIG. 5 stored in the storage unit 205. Next, the processing proceeds to step S1103, the CPU 201 references, for example, the button information table in FIG. 7 managed by the button management module 431, and references the function category information associated with a button to be displayed in the top menu. Note that a configuration may be employed in which the user management table in FIG. 5 is stored in an external access management server, and in step S1102, the CPU 201 gives a request to the external access management server and obtains the access restriction information of the authenticated user.

Next, the processing proceeds to step S1104, and the CPU 201 determines whether or not the function category information associated with the button is “BookMark”, which indicates an attribute of a bookmark. If the function category information is “BookMark”, the processing proceeds to step S1105, and the CPU 201 references the bookmark information table in FIG. 6, for example. If function category information other than “BookMark” is registered, the processing proceeds to step S1106, and the CPU 201 determines control of access to the function of this button by the user.

In step S1105, the CPU 201 obtains the function category information regarding an item of the bookmark information table (FIG. 6) that matches the title of the button, based on “Title” of the button whose function category information is “BookMark” in the button information table in FIG. 7, for example. Note that a configuration may be employed in which identification information other than “Title” is provided in FIGS. 6 and 7, and the function category information associated with each button is obtained based on the identification information in FIGS. 6 and 7. The processing then proceeds to step S1107, the CPU 201 references the function category information obtained in step S1105 and the access restriction information of the user obtained in step S1102, and determines whether or not to perform access restriction on this button. For example, in the above-described example, the title of the button whose function category information is “BookMark” in FIG. 7 is “Scan Web Application”, which corresponds to the row 604 in the bookmark information table in FIG. 6, and the function category information thereof is “Scan to SMB”. Accordingly, it can be found from the user management table in FIG. 5 that access of the user A to this function is restricted.

Note that the determination in step S1107 is performed based not on the function category information managed by the button information table (FIG. 7) but on the function category information managed by the bookmark information table (FIG. 6). For this reason, even if use of the Web browser 420 by a user is restricted, this user is able to use the Web application 410 of the server 102. Furthermore, even when the Web browser 420 is available, access to the scan Web application function, the print Web application function, or the like by the Web application 410 can be restricted.

After step S1106 or step S1107 is thus executed, the processing proceeds to step S1108, and if a function is restricted in accordance with the content of the determination in step S1106 or step S1107, the CPU 201 proceeds to the button inactivation processing in step S1109. On the other hand, if a function is not restricted, the CPU 201 proceeds to the button activation processing in step S1110. In step S1109, the corresponding button in the top menu is displayed while being grayed out (e.g., buttons 911 and 913 in FIG. 9B) such that, even if this button is operated, this operation is not accepted. On the other hand, in step S1110, the corresponding button in the top menu is normally displayed so as to be able to accept an operation to this button.

After step S1109 or step S1110 is thus executed, the processing proceeds to step S1111, and the CPU 201 determines whether or not a button exists regarding which the determination of restriction of access to the function corresponding to this button has not been performed, among the buttons to be displayed in the top menu. Here, if the determination of access restriction has been performed for all buttons, the processing proceeds to step S1112, the CPU 201 displays the top menu screen, and ends this processing. On the other hand, if the CPU 201 determines in step S1111 that an unprocessed button exists among the buttons displayed in the top menu, the processing returns to step S1103, and the CPU 201 references the next button in the button information table and executes the above-described processing.

FIGS. 12A to 12C are diagrams each showing an exemplary screen of the print Web application displayed by the Web browser 420. This screen is an exemplary screen of the print Web application displayed by the Web browser 420. Upon a URL being input on the Web browser 420 by the user, this screen is displayed, which is a screen obtained from the Web server in accordance with the input URL. After the print Web application is bookmarked, a screen obtained from the Web server is displayed in accordance with a URL registered in association with the bookmark.

FIG. 12A shows an exemplary screen for selecting data to be printed, and a bookmark button 1201 is a button for calling a bookmark management dialog 1210 in FIG. 12B, for example. Upon this bookmark button 1201 being pressed by the user, the bookmark management dialog 1210 shown in FIG. 12B is displayed.

FIG. 12B is a diagram showing an exemplary bookmark management dialog 1210.

The bookmark management dialog 1210 includes a bookmark display section 1211, a URL input field 1212, a go button 1213, an add button 1214, and a delete button 1215.

A list of bookmarks managed by the bookmark management module 424 is displayed in the bookmark display section 1211. The URL input field 1212 is an input field in which a URL to be bookmarked is input. When the bookmark management dialog 1210 is displayed, a URL of a page whose bookmark button is pressed may be displayed in the URL input field 1212. In the case of the example shown in FIGS. 12A to 12C, a URL of a site of the print Web application may be displayed. The go button 1213 is a button for opening a bookmark selected from the bookmark display section 1211 by the user. Upon the go button 1213 being pressed by the user in a state where any bookmark displayed in the bookmark display section 1211 is selected, a URL of the selected bookmark is loaded on the Web browser 420. The add button 1214 is a button for adding a bookmark to a URL that is currently input in the URL input field 1212. Upon the add button 1214 being pressed, a function category information select dialog 1220 (FIG. 12C) for registering the function category information managed by the bookmark management module 424 is displayed. The delete button 1215 is a button for deleting a bookmark selected from the bookmark display section 1211 by the user. Upon the delete button 1215 being pressed in a state where any bookmark displayed in the bookmark display section 1211 is selected, information of the selected bookmark is deleted from the bookmark management module 424, and is also erased from the bookmark display section 1211.

Note that the URL input field 1212, the add button 1214, and the delete button 1215 can be operated only in the case where the authenticated user is an administrator. That is to say, only a user whose “Role” in the user management table in FIG. 5 is “Administrator” can operate these buttons, and a non-administrator (GeneralUser) cannot operate the buttons.

FIG. 12C is a diagram showing an exemplary function category information select dialog 1220.

The user can select a function category that is closest to a function implemented by a Web application from among items in a function category option list 1221. Upon the user selecting a function in the list 1221 and pressing a register button 1222, the selected function category information and the URL input via the URL input field 1212 are associated with each other and are registered in the bookmark management module 424. Upon the user selecting a function in the list 1221 and pressing the delete button 1223, the selected function category option is deleted from the bookmark management module 424.

FIG. 13 is a flowchart for describing bookmark registration processing performed by the MFP 101 according to the embodiment. A program for executing this processing is stored in the storage unit 205, and at the time of the execution, the program is deployed in the RAM 202 and executed by the CPU 201, and the processing shown by this flowchart is thereby achieved.

This processing is started by the user pressing the bookmark button 1201 in FIG. 12A, for example. Initially, in step S1302, the CPU 201 displays the bookmark management dialog 1210 shown in FIG. 12B, for example. Next, the processing proceeds to step S1303, and the CPU 201 determines the authority of the user authenticated in step S1006 (FIG. 10). Here, the CPU 201 determines whether or not the authenticated user has administrator authority. If it is determined here that the authenticated user is a user having the administrator authority, the processing proceeds to step S1304, the CPU 201 activates the URL input field 1212, the add button 1214, and the delete button 1215 in FIG. 12B, and the processing proceeds to step S1306. On the other hand, if it is determined that the authenticated user is a user who does not have the administrator authority, the processing proceeds to step S1305, the CPU 201 inactivates the URL input field 1212, the add button 1214, and the delete button 1215, and ends the processing.

In step S1306, the CPU 201 obtains the URL input in the URL input field 1212 by the user. Next, the processing proceeds to step S1307, and if the CPU 201 detects that the add button 1214 has been pressed on the screen in FIG. 12B, the processing proceeds to step S1308. In step S1308, the CPU 201 displays the function category information select dialog 1220 shown in FIG. 12C, for example, and obtains the function category information selected by the user. Next, the processing proceeds to step S1309, and if the CPU 201 detects that the user has pressed the register button 1222, the processing proceeds to step S1310. In step S1310, the CPU 201 registers the site name, the URL, and the function category information in the bookmark information table (FIG. 6) managed by the bookmark management module 424. Simultaneously, the CPU 201 registers the title 701, which is the site name, and the function category information 702 in the button information table (FIG. 7) managed by the button management module 431. Note that the site name may be automatically obtained from the URL to be registered, or a site name input field may be separately provided in the bookmark management dialog 1210 such that the user can input any site name.

With the above-described configuration, when the Web browser registers a bookmark, the Web browser registers the function category information and a URL together. Upon a user logging in to the MFP, the function category information of a shortcut button for a bookmark of a Web application that is registered in association with the user is referenced, and the button can be activated/inactivated. It is thereby possible to maintain security and usability even in the case of using a bookmark shortcut button of the Web application.

### Other Embodiments

Although the above embodiment has described an example in which one title corresponds to one item of the function category information, it should be noted that one title may correspond to a plurality of items of the function category information. In this case, the button of this title may be activated under a condition that the user can use (“Permit”) all of a plurality of functions indicated by the plurality of items of the function category information. Also, the button of this title may be inactivated under a condition that the user cannot use (“Deny”) at least any one of the plurality of functions indicated by the plurality of items of the function category information.

The above embodiment has described an example in which a function that a user does not have the authority to use is inactivated by displaying the button for using this function while graying out the button. However, the example of the inactivation is not limited thereto, and the CPU 201 may perform control such that an error message is displayed when the button for using the function that the user does not have the authority to use is pressed. Alternatively, the CPU 201 may perform control such that the button for using the function that the user does not have the authority to use is not displayed.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Note, the present invention is not limited to the embodiment described above, and it is possible to make various modifications or changes without straying from the spirit and scope of the present invention. Accordingly, the following claims are attached to make public the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-150133, filed Jul. 23, 2014 which is hereby incorporated by reference herein in its entirety.

What is claimed is:

1. An information processing apparatus having a browser function, the apparatus comprising:
a first storing unit configured to store access restriction information regarding restriction of access to a function, in association with a user;
a holding unit configured to hold, as bookmark information, a URL of a connection destination and function category information indicating a function of the connection destination;
a second storing unit configured to store, as button information, information of a button to be displayed on a menu screen and a function associated with the button, and information regarding whether the button has an attribute of the bookmark information;
a determination unit configured to determine, if the button information of a button included in the menu screen is the bookmark information when displaying the menu screen, whether or not the function category information of the bookmark information corresponds to a function that is restricted by the access restriction information corresponding to a user who has logged in; and
a control unit configured to perform control for displaying the menu screen such that a button corresponding to the bookmark information is not able to be operated, if it is determined by the determination unit that the function category information of the bookmark information corresponds to the function that is restricted by the access restriction information corresponding to the user who has logged in.

2. The apparatus according to claim 1, further comprising an authentication unit configured to authenticate a user,
wherein a user regarding whom authentication by the authentication unit has been successful is the user who has logged in.

3. The apparatus according to claim 1, further comprising:
an input unit configured to input a URL of a connection destination;
a selection unit configured to select a function category corresponding to the URL input by the input unit from an option list; and
a registration unit configured to register, as the bookmark information, the URL input by the input unit and the function category selected by the selection unit in association with each other.

4. The apparatus according to claim 3, wherein the input unit, the selection unit, and the registration unit are started if the user who has logged in has administrator authority.

5. The apparatus according to claim 1, wherein if the function associated with the button is included in the bookmark information, the button information explicitly indicates the bookmark information with respect to the function associated with the button.

6. The apparatus according to claim 1, wherein the control unit displays the button corresponding to the bookmark information while graying out the button.

7. The apparatus according to claim 1, wherein the function includes a function that the information processing apparatus has and a function implemented by the browser function.

8. The apparatus according to claim 1, wherein the button is a shortcut button.

9. A method of controlling an information processing apparatus having a browser function, the method comprising:
storing access restriction information regarding restriction of access to a function, in association with a user;
holding, as bookmark information, a URL of a connection destination and function category information indicating a function of the connection destination;
storing, as button information, information of a button to be displayed on a menu screen and a function associated with the button, and information regarding whether the button has an attribute of the bookmark information;
determining, if the button information of a button included in the menu screen is the bookmark information when displaying the menu screen, whether or not the function category information of the bookmark information corresponds to a function that is restricted by the access restriction information corresponding to a user who has logged in; and
performing control for displaying the menu screen such that a button corresponding to the bookmark information is not able to be operated, if it is determined in the determining that the function category information of the bookmark information corresponds to the function that is restricted by the access restriction information corresponding to the user who has logged in.

10. A non-transitory computer-readable storage medium storing a program for causing a computer to function as an information processing apparatus having a browser function, the apparatus comprising:
a first storing unit configured to store access restriction information regarding restriction of access to a function, in association with a user;
a holding unit configured to hold, as bookmark information, a URL of a connection destination and function category information indicating a function of the connection destination;
a second storing unit configured to store, as button information, information of a button to be displayed on a menu screen and a function associated with the button, and information regarding whether the button has an attribute of the bookmark information;
a determination unit configured to determine, if the button information of a button included in the menu screen is the bookmark information when displaying the menu screen, whether or not the function category information of the bookmark information corresponds to a function that is restricted by the access restriction information corresponding to a user who has logged in; and
a control unit configured to perform control for displaying the menu screen such that a button corresponding to the bookmark information is not able to be operated, if it is determined by the determination unit that the function category information of the bookmark information corresponds to the function that is restricted by the access restriction information corresponding to the user who has logged in.
